(19) United States
(12) Patent Application Publication
(10) Pub. No.: US 2023/0182304 A1
(43) Pub. Date: Jun. 15, 2023

(54) SYSTEMS AND METHODS OF LIGHTING FOR A MOBILE ROBOT

(71) Applicant: Boston Dynamics, Inc., Waltham, MA (US)

(72) Inventor: Matthew Paul Meduna, Waltham, MA (US)

(73) Assignee: Boston Dynamics, Inc., Waltham, MA (US)

(21) Appl. No.: 17/988,473

(22) Filed: Nov. 16, 2022

Related U.S. Application Data
(60) Provisional application No. 63/288,382, filed on Dec. 10, 2021.

(51) Int. Cl. B25J 9/16; B25J 5/00

(52) U.S. Cl. CPC B25J 9/1674; B25J 5/007; B25J 9/1664

(57) ABSTRACT

Methods and apparatus for controlling lighting of a mobile robot are provided. A mobile robot includes a drive system configured to enable the mobile robot to be driven, a navigation module configured to provide control instructions to the drive system, a plurality of lighting modules, wherein each of the plurality of lighting modules includes a plurality of individually-controllable light sources, and a controller configured to control an operation of the plurality of individually-controllable light sources based, at least in part, on navigation information received from the navigation module.

### CROSS REFERENCE TO RELATED APPLICATIONS

This application claims the benefit under 35 U.S.C. § 119(e) of U.S. Provisional application Ser. No. 63/288,382, filed Dec. 10, 2021, and entitled, “SYSTEMS AND METHOD OF LIGHTING FOR A MOBILE ROBOT,” the disclosure of which is incorporated by reference in its entirety.

### BACKGROUND

A robot is generally defined as a reprogrammable and multifunctional manipulator designed to move material, parts, tools, or specialized devices through variable programmed motions for a performance of tasks. Robots may be manipulators that are physically anchored (e.g., industrial robotic arms), mobile robots that move throughout an environment (e.g., using legs, wheels, or traction-based mechanisms), or some combination of a manipulator and a mobile robot. Robots are utilized in a variety of industries including, for example, manufacturing, warehouse logistics, transportation, hazardous environments, exploration, and healthcare.

### SUMMARY

Providing cues to others (e.g., people and other robots) in an environment in which an omnidirectional autonomous robot is operating can help to signal an intent of the robot to move in a particular direction. The use of traditional headlights or taillights fixed in place on opposite sides of the robot may require the robot to rotate frequently such that the robot drives with the headlights in front and the taillights in the rear. Additionally, in a scenario in which the omnidirectional robot is manually controlled by an operator, cues should be provided to enable the operator to know how the robot will react when instructions are provided to move the robot in a particular direction. Failure to provide such cues may result in inadvertent collisions between the robot and other objects in the robot's environment. To this end, some embodiments relate to an omnidirectional robot that includes a plurality of individually-controllable lighting modules that can be used to provide visual cues about the orientation and/or movement direction of the robot. The individually-controllable lighting modules may be programmed to change in real time based on the behavior of the robot to enable operation of the omnidirectional robot in a safe and controlled manner. Status information indicating a status of the robot may additionally be shown using the individually-controllable lighting modules in some embodiments.

An aspect of the present disclosure provides a mobile robot. The mobile robot comprises a drive system configured to enable the mobile robot to be driven, a navigation module configured to provide control instructions to the drive system, a plurality of lighting modules, wherein each of the plurality of lighting modules includes a plurality of individually-controllable light sources, and a controller configured to control an operation of the plurality of individually-controllable light sources based, at least in part, on navigation information received from the navigation module.

In another aspect, the plurality of individually-controllable light sources are programmable light emitting diodes (LEDs).

In another aspect, the mobile robot further comprises a mobile base, and the plurality of lighting modules are disposed in the mobile base.

In another aspect, the plurality of lighting modules are disposed at corners of the mobile base.

In another aspect, controlling an operation of the plurality of individually-controllable light sources based, at least in part, on navigation information received from the navigation module comprises controlling the plurality of individually-controllable light sources to indicate a current travel direction of the mobile robot.

In another aspect, controlling the plurality of individually-controllable light sources to indicate the current travel direction of the mobile robot comprises controlling a first set of lighting modules to display a white color and/or controlling a second set of lighting modules to display a red color, wherein the first set is located relative to the second set in the current travel direction of the mobile robot.

In another aspect, the navigation information received from the navigation module includes a direction of motion indicating a future travel direction of the mobile robot, and controlling an operation of the plurality of individually-controllable light sources comprises controlling the plurality of individually-controllable light sources to indicate the future travel direction of the mobile robot.

In another aspect, controlling the plurality of individually-controllable light sources to indicate the future travel direction of the mobile robot comprises controlling a first set of lighting modules to display a white color and/or controlling a second set of lighting modules to display a red color, wherein the first set is located relative to the second set in a current travel direction of the mobile robot, controlling a third set of lighting modules to display the white color and/or controlling a fourth set of lighting modules to display the red color, wherein the third set is different from the first set and the fourth set is different from the second set.

In another aspect, the navigation information received from the navigation module includes a direction of motion indicating a future travel direction of the mobile robot, and wherein controlling an operation of the plurality of individually-controllable light sources comprises controlling the plurality of individually-controllable light sources to indicate the future travel direction of the mobile robot without rotating the mobile base.

In another aspect, the navigation information received from the navigation module includes speed information for the mobile robot, and controlling an operation of the plurality of individually-controllable light sources based, at least in part, on navigation information comprises controlling the plurality of individually-controllable light sources to indicate the speed information for the mobile robot.

In another aspect, controlling the plurality of individually-controllable light sources to indicate the speed information for the mobile robot comprises changing a brightness of one or more of the plurality of individually-controllable light sources when the mobile robot is decelerating.

In another aspect, the mobile robot further comprises a mode determining component configured to determine whether the mobile robot is operating in an autonomous mode or a manual mode, and the controller is further configured to control the operation of the plurality of individually-controllable light sources based, at least in part, on whether the mobile robot is determined to be operating in the autonomous mode or the manual mode.

In another aspect, the mode determining component is an electrical interface configured to couple to a pendant accessory.

In another aspect, the controller is configured to control the operation of the plurality of individually-controllable light sources to indicate a movement intent of the mobile robot when it is determined that the mobile robot is operating in autonomous mode, and the controller is configured to control the operation of the plurality of individually-controllable light sources to indicate an orientation of the mobile robot relative to a reference frame when it is determined that the mobile robot is operating in manual mode.

In another aspect, the mobile robot further comprise a status tracker module configured to determine status information associated with one or more operations of the mobile robot, and the controller is further configured to control the operation of the plurality of individually-controllable light sources to indicate status information received from the status tracker module.

In another aspect, the controller is further configured to control the operation of the plurality of individually-controllable light sources to indicate the status information and navigation information at a same time.

In another aspect, the controller is further configured to control the operation of at least one of the plurality of lighting modules to indicate the status information and the navigation information at the same time.

In another aspect, the drive system is an omnidirectional drive system.

Another aspect of the present disclosure provides a method of controlling a plurality of lighting modules disposed on a mobile robot, each of the plurality of lighting modules including a plurality of individually-controllable light sources. The method comprises receiving navigation information indicating a direction of motion of the mobile robot, and controlling, by at least one computing device, an operation of the plurality of individually-controllable light sources to indicate the direction of motion of the mobile robot.

In another aspect, controlling an operation of the plurality of individually-controllable light sources to indicate the direction of motion of the robot comprises controlling at least some of the plurality of individually-controllable light sources to indicate a current travel direction of the mobile robot.

In another aspect, controlling at least some of the plurality of individually-controllable light sources to indicate the current travel direction of the mobile robot comprises controlling a first set of lighting modules to display a white color and/or controlling a second set of lighting modules to display a red color, wherein the first set is located relative to the second set in the current travel direction of the mobile robot.

In another aspect, controlling an operation of the plurality of individually-controllable light sources to indicate the direction of motion of the robot comprises controlling at least some of the plurality of individually-controllable light sources to indicate a future travel direction of the mobile robot.

In another aspect, controlling at least some of the plurality of individually-controllable light sources to indicate the future travel direction of the mobile robot comprises controlling a first set of lighting modules to display a white color and/or controlling a second set of lighting modules to display a red color, wherein the first set is located relative to the second set in a current travel direction of the mobile robot, controlling a third set of lighting modules to display the white color and/or controlling a fourth set of lighting modules to display the red color, wherein the third set is different from the first set and the fourth set is different from the second set.

In another aspect, controlling at least some of the plurality of individually-controllable light sources to indicate the future travel direction of the mobile robot comprises indicating the future travel direction of the mobile robot without rotating a mobile based of the mobile robot.

In another aspect, the navigation information includes speed information for the mobile robot, and the method further comprises controlling an operation of the plurality of individually-controllable light sources to indicate the speed information for the mobile robot.

In another aspect, controlling the plurality of individually-controllable light sources to indicate the speed information comprises changing a brightness of one or more of the plurality of individually-controllable light sources when the mobile robot is decelerating.

In another aspect, the method further comprises determining whether the mobile robot is operating in an autonomous mode or a manual mode, and controlling the operation of the plurality of individually-controllable light sources based, at least in part, on whether the mobile robot is determined to be operating in the autonomous mode or the manual mode.

In another aspect, determining whether the mobile robot is operating in an autonomous mode or a manual mode comprises determining that the mobile robot is operating in the manual mode when a pendant accessory is communicatively coupled to the mobile robot.

In another aspect, controlling the operation of the plurality of individually-controllable light sources based, at least in part, on whether the mobile robot is determined to be operating in the autonomous mode or the manual mode comprises controlling the operation of the plurality of individually-controllable light sources to indicate a movement intent of the mobile robot when it is determined that the mobile robot is operating in autonomous mode, and controlling the operation of the plurality of individually-controllable light sources to indicate an orientation of the mobile robot relative to a reference frame when it is determined that the mobile robot is operating in manual mode.

In another aspect, the method further comprises controlling the operation of the plurality of individually-controllable light sources to indicate status information associated with the mobile robot.

In another aspect, the method further comprises controlling the operation of the plurality of individually-controllable light sources to indicate status information and the direction of motion of the mobile robot at a same time.

In another aspect, controlling the operation of the plurality of individually-controllable light sources to indicate status information and the direction of motion of the mobile robot at a same time comprises controlling the operation of the plurality of individually-controllable light sources for one of the plurality of lighting modules such that the lighting module indicates the status information and the direction of motion of the mobile robot at the same time.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1A is a perspective view of one embodiment of a robot;

FIG. 1B is another perspective view of the robot of FIG. 1A;

FIG. 2A depicts robots performing tasks in a warehouse environment;

FIG. 2B depicts a robot unloading boxes from a truck;

FIG. 2C depicts a robot building a pallet in a warehouse aisle;

FIG. 2D depicts a robot coupled to a pendant accessory through an electrical interface of the robot;

FIG. 2E depicts one embodiment of a pendant accessory for use with some embodiments;

FIG. 3 depicts a robot having a plurality of lighting modules disposed thereon;

FIG. 4 is an illustrative computing architecture for a robotic device that may be used in accordance with some embodiments;

FIG. 5 is a flowchart of a process for controlling a plurality of lighting modules of a robot based on navigation information associated with the robot in accordance with some embodiments; and

FIG. 6 is a flowchart of a process for controlling a plurality of lighting modules of a robot based on navigation information associated with the robot in accordance with some embodiments.

### DETAILED DESCRIPTION

Robots are typically configured to perform various tasks in an environment in which they are placed. Generally, these tasks include interacting with objects and/or the elements of the environment. Notably, robots are becoming popular in warehouse and logistics operations. Before the introduction of robots to such spaces, many operations were performed manually. For example, a person might manually unload boxes from a truck onto one end of a conveyor belt, and a second person at the opposite end of the conveyor belt might organize those boxes onto a pallet. The pallet may then be picked up by a forklift operated by a third person, who might drive to a storage area of the warehouse and drop the pallet for a fourth person to remove the individual boxes from the pallet and place them on shelves in the storage area. More recently, robotic solutions have been developed to automate many of these functions. Such robots may either be specialist robots (i.e., designed to perform a single task, or a small number of closely related tasks) or generalist robots (i.e., designed to perform a wide variety of tasks). To date, both specialist and generalist warehouse robots have been associated with significant limitations, as explained below.

A specialist robot may be designed to perform a single task, such as unloading boxes from a truck onto a conveyor belt. While such specialist robots may be efficient at performing their designated task, they may be unable to perform other, tangentially related tasks in any capacity. As such, either a person or a separate robot (e.g., another specialist robot designed for a different task) may be needed to perform the next task(s) in the sequence. As such, a warehouse may need to invest in multiple specialist robots to perform a sequence of tasks, or may need to rely on a hybrid operation in which there are frequent robot-to-human or human-to-robot handoffs of objects.

In contrast, a generalist robot may be designed to perform a wide variety of tasks, and may be able to take a box through a large portion of the box's life cycle from the truck to the shelf (e.g., unloading, palletizing, transporting, depalletizing, storing). While such generalist robots may perform a variety of tasks, they may be unable to perform individual tasks with high enough efficiency or accuracy to warrant introduction into a highly streamlined warehouse operation. For example, while mounting an off-the-shelf robotic manipulator onto an off-the-shelf mobile robot might yield a system that could, in theory, accomplish many warehouse tasks, such a loosely integrated system may be incapable of performing complex or dynamic motions that require coordination between the manipulator and the mobile base, resulting in a combined system that is inefficient and inflexible. Typical operation of such a system within a warehouse environment may include the mobile base and the manipulator operating sequentially and (partially or entirely) independently of each other. For example, the mobile base may first drive toward a stack of boxes with the manipulator powered down. Upon reaching the stack of boxes, the mobile base may come to a stop, and the manipulator may power up and begin manipulating the boxes as the base remains stationary. After the manipulation task is completed, the manipulator may again power down, and the mobile base may drive to another destination to perform the next task. As should be appreciated from the foregoing, the mobile base and the manipulator in such systems are effectively two separate robots that have been joined together; accordingly, a controller associated with the manipulator may not be configured to share information with, pass commands to, or receive commands from a separate controller associated with the mobile base. As such, such a poorly integrated mobile manipulator robot may be forced to operate both its manipulator and its base at suboptimal speeds or through suboptimal trajectories, as the two separate controllers struggle to work together. Additionally, while there are limitations that arise from a purely engineering perspective, there are additional limitations that must be imposed to comply with safety regulations. For instance, if a safety regulation requires that a mobile manipulator must be able to be completely shut down within a certain period of time when a human enters a region within a certain distance of the robot, a loosely integrated mobile manipulator robot may not be able to act sufficiently quickly to ensure that both the manipulator and the mobile base (individually and in aggregate) do not a pose a threat to the human. To ensure that such loosely integrated systems operate within required safety constraints, such systems are forced to operate at even slower speeds or to execute even more conservative trajectories than those limited speeds and trajectories as already imposed by the engineering problem. As such, the speed and efficiency of generalist robots performing tasks in warehouse environments to date have been limited.

In view of the above, the inventors have recognized and appreciated that a highly integrated mobile manipulator robot with system-level mechanical design and holistic control strategies between the manipulator and the mobile base may be associated with certain benefits in warehouse and/or logistics operations. Such an integrated mobile manipulator robot may be able to perform complex and/or dynamic motions that are unable to be achieved by conventional, loosely integrated mobile manipulator systems. As a result, this type of robot may be well suited to perform a variety of different tasks (e.g., within a warehouse environment) with speed, agility, and efficiency.

### Example Robot Overview

In this section, an overview of some components of one embodiment of a highly integrated mobile manipulator robot configured to perform a variety of tasks is provided to explain the interactions and interdependencies of various subsystems of the robot. Each of the various subsystems, as well as control strategies for operating the subsystems, are described in further detail in the following sections.

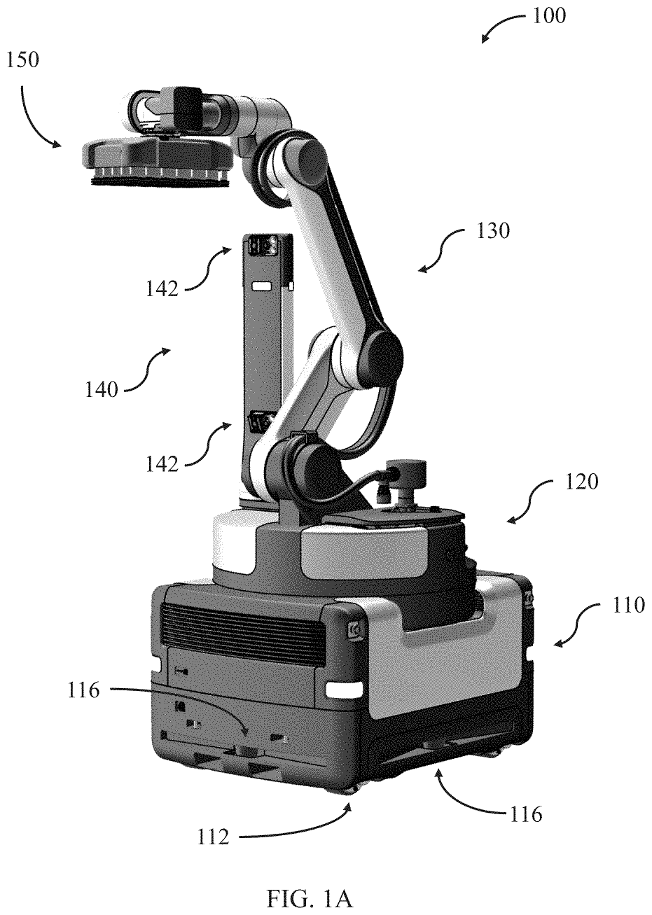

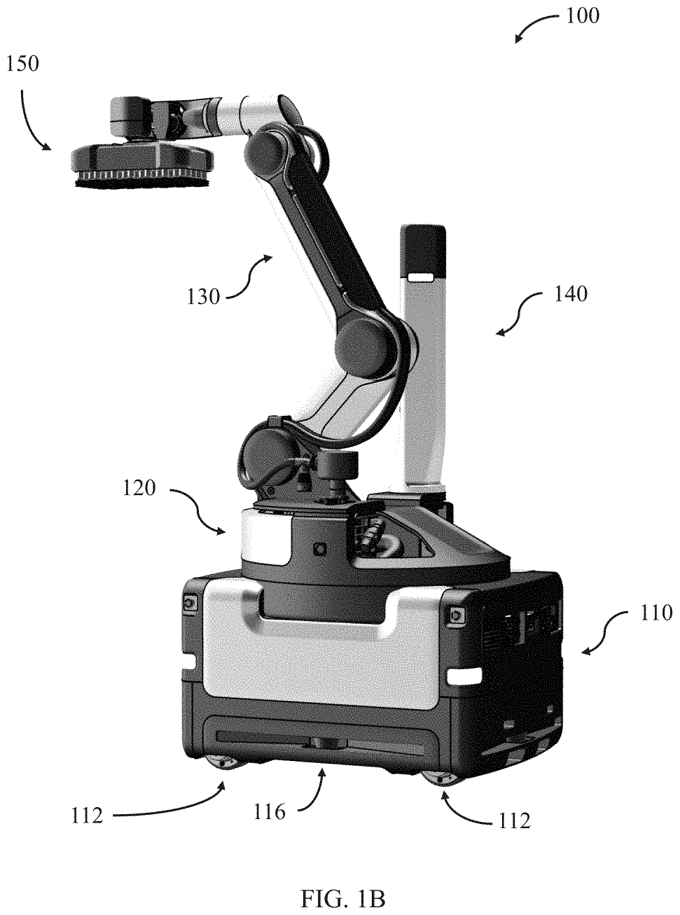

FIGS. 1A and 1B are perspective views of one embodiment of a robot 100. The robot 100 includes a mobile base 110 and a robotic arm 130. The mobile base 110 includes an omnidirectional drive system that enables the mobile base to translate in any direction within a horizontal plane as well as rotate about a vertical axis perpendicular to the plane. Each wheel 112 of the mobile base 110 is independently steerable and independently drivable. The mobile base 110 additionally includes a number of distance sensors 116 that assist the robot 100 in safely moving about its environment. The robotic arm 130 is a 6 degree of freedom (6-DOF) robotic arm including three pitch joints and a 3-DOF wrist. An end effector 150 is disposed at the distal end of the robotic arm 130. The robotic arm 130 is operatively coupled to the mobile base 110 via a turntable 120, which is configured to rotate relative to the mobile base 110. In addition to the robotic arm 130, a perception mast 140 is also coupled to the turntable 120, such that rotation of the turntable 120 relative to the mobile base 110 rotates both the robotic arm 130 and the perception mast 140. The robotic arm 130 is kinematically constrained to avoid collision with the perception mast 140. The perception mast 140 is additionally configured to rotate relative to the turntable 120, and includes a number of perception modules 142 configured to gather information about one or more objects in the robot's environment. The integrated structure and system-level design of the robot 100 enable fast and efficient operation in a number of different applications, some of which are provided below as examples.

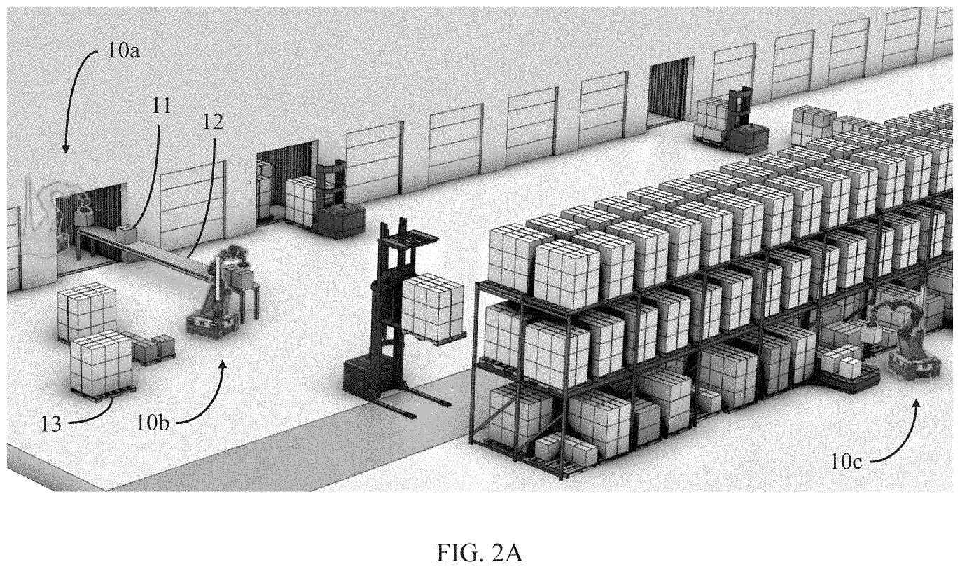

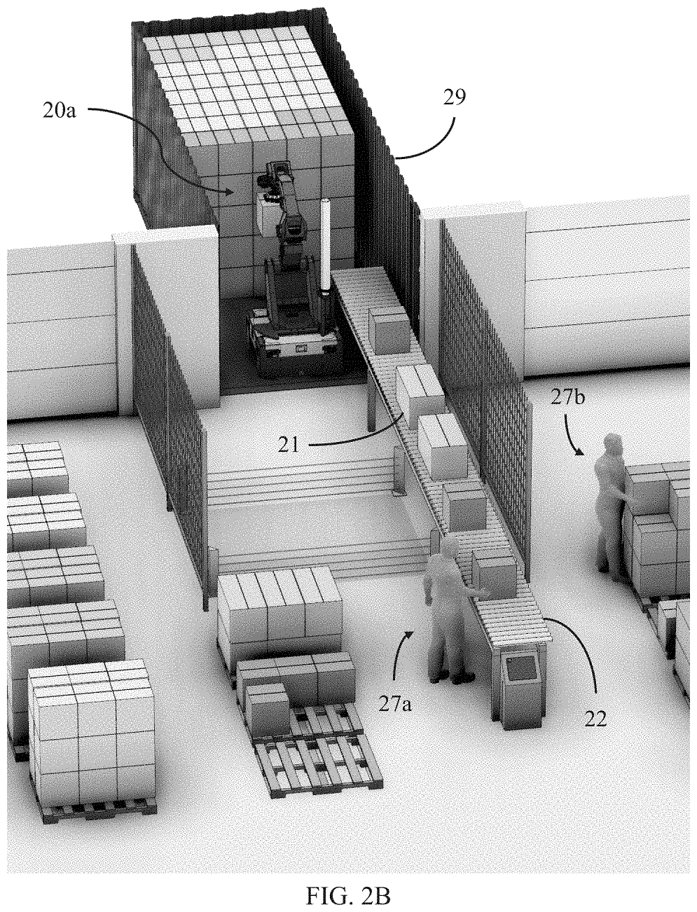

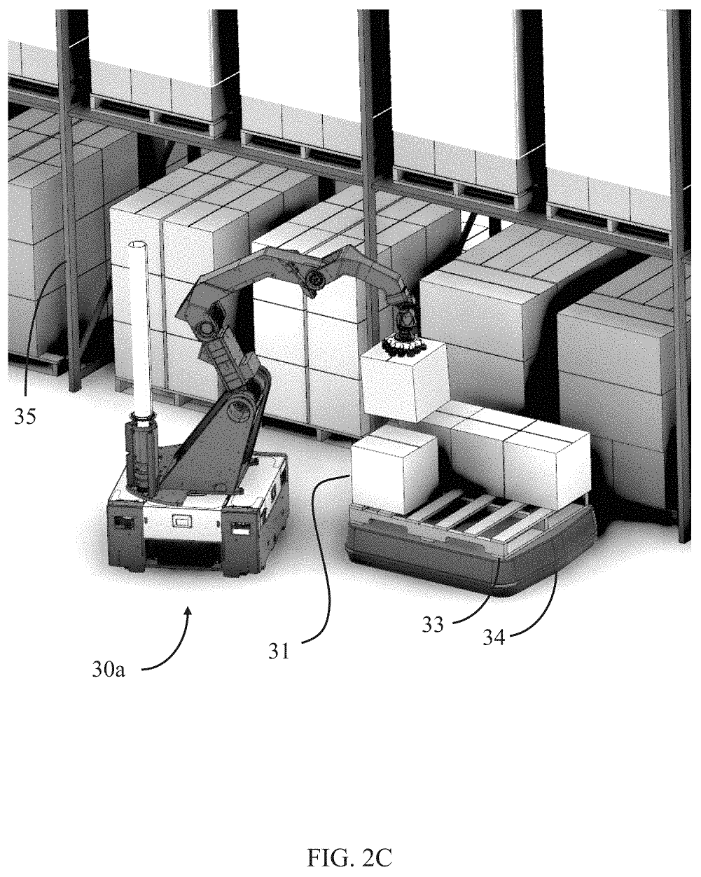

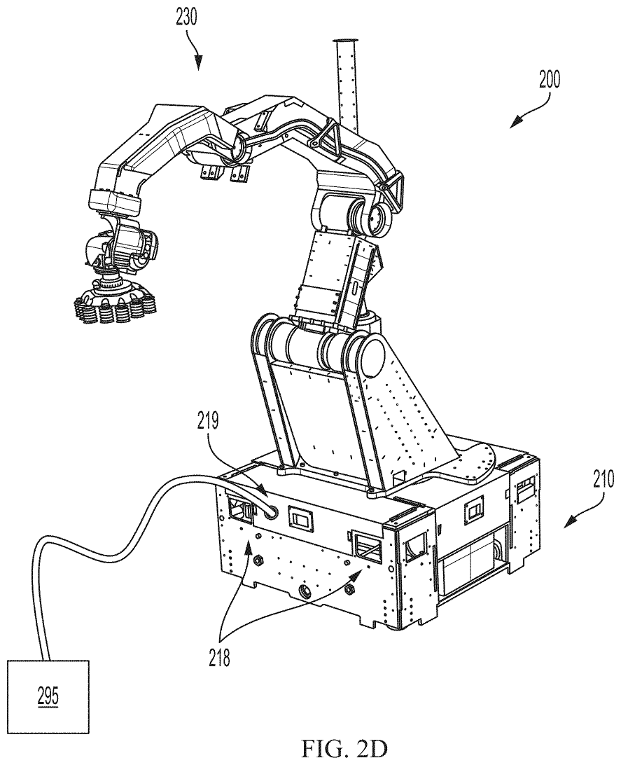

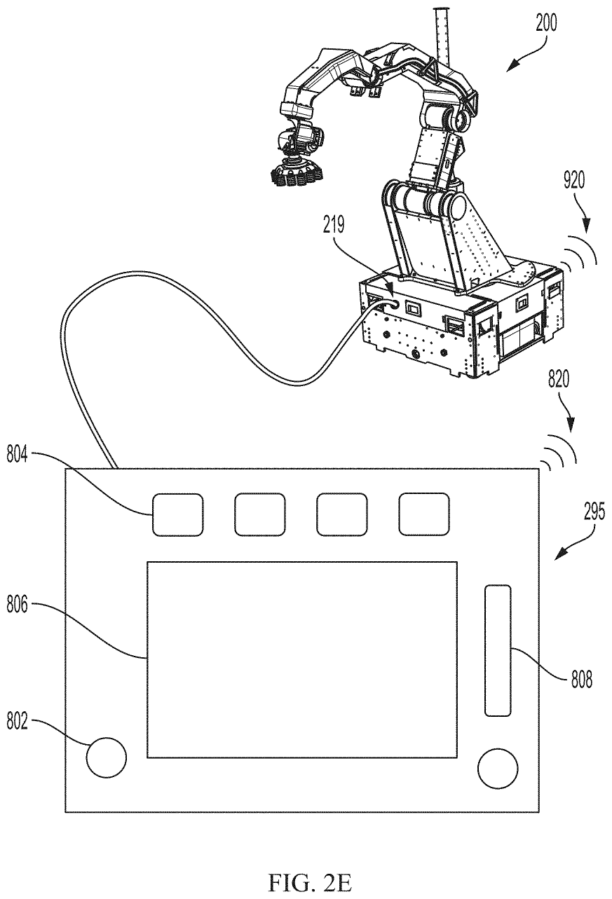

FIG. 2A depicts robots 10a, 10b, and 10c performing different tasks within a warehouse environment. A first robot 10a is inside a truck (or a container), moving boxes 11 from a stack within the truck onto a conveyor belt 12 (this particular task will be discussed in greater detail below in reference to FIG. 2B). At the opposite end of the conveyor belt 12, a second robot 10b organizes the boxes 11 onto a pallet 13. In a separate area of the warehouse, a third robot 10c picks boxes from shelving to build an order on a pallet (this particular task will be discussed in greater detail below in reference to FIG. 2C). It should be appreciated that the robots 10a, 10b, and 10c are different instances of the same robot (or of highly similar robots). Accordingly, the robots described herein may be understood as specialized multi-purpose robots, in that they are designed to perform specific tasks accurately and efficiently, but are not limited to only one or a small number of specific tasks.

FIG. 2B depicts a robot 20a unloading boxes 21 from a truck 29 and placing them on a conveyor belt 22. In this box picking application (as well as in other box picking applications), the robot 20a will repetitiously pick a box, rotate, place the box, and rotate back to pick the next box. Although robot 20a of FIG. 2B is a different embodiment from robot 100 of FIGS. 1A and 1B, referring to the components of robot 100 identified in FIGS. 1A and 1B will ease explanation of the operation of the robot 20a in FIG. 2B. During operation, the perception mast of robot 20a (analogous to the perception mast 140 of robot 100 of FIGS. 1A and 1B) may be configured to rotate independent of rotation of the turntable (analogous to the turntable 120) on which it is mounted to enable the perception modules (akin to perception modules 142) mounted on the perception mast to capture images of the environment that enable the robot 20a to plan its next movement while simultaneously executing a current movement. For example, while the robot 20a is picking a first box from the stack of boxes in the truck 29, the perception modules on the perception mast may point at and gather information about the location where the first box is to be placed (e.g., the conveyor belt 22). Then, after the turntable rotates and while the robot 20a is placing the first box on the conveyor belt, the perception mast may rotate (relative to the turntable) such that the perception modules on the perception mast point at the stack of boxes and gather information about the stack of boxes, which is used to determine the second box to be picked. As the turntable rotates back to allow the robot to pick the second box, the perception mast may gather updated information about the area surrounding the conveyor belt. In this way, the robot 20a may parallelize tasks which may otherwise have been performed sequentially, thus enabling faster and more efficient operation.

Also of note in FIG. 2B is that the robot 20a is working alongside humans (e.g., workers 27a and 27b). Given that the robot 20a is configured to perform many tasks that have traditionally been performed by humans, the robot 20a is designed to have a small footprint, both to enable access to areas designed to be accessed by humans, and to minimize the size of a safety zone around the robot into which humans are prevented from entering.

FIG. 2C depicts a robot 30a performing an order building task, in which the robot 30a places boxes 31 onto a pallet 33. In FIG. 2C, the pallet 33 is disposed on top of an autonomous mobile robot (AMR) 34, but it should be appreciated that the capabilities of the robot 30a described in this example apply to building pallets not associated with an AMR. In this task, the robot 30a picks boxes 31 disposed above, below, or within shelving 35 of the warehouse and places the boxes on the pallet 33. Certain box positions and orientations relative to the shelving may suggest different box picking strategies. For example, a box located on a low shelf may simply be picked by the robot by grasping a top surface of the box with the end effector of the robotic arm (thereby executing a “top pick”). However, if the box to be picked is on top of a stack of boxes, and there is limited clearance between the top of the box and the bottom of a horizontal divider of the shelving, the robot may opt to pick the box by grasping a side surface (thereby executing a “face pick”).

To pick some boxes within a constrained environment, the robot may need to carefully adjust the orientation of its arm to avoid contacting other boxes or the surrounding shelving. For example, in a typical “keyhole problem”, the robot may only be able to access a target box by navigating its arm through a small space or confined area (akin to a keyhole) defined by other boxes or the surrounding shelving. In such scenarios, coordination between the mobile base and the arm of the robot may be beneficial. For instance, being able to translate the base in any direction allows the robot to position itself as close as possible to the shelving, effectively extending the length of its arm (compared to conventional robots without omnidirectional drive which may be unable to navigate arbitrarily close to the shelving). Additionally, being able to translate the base backwards allows the robot to withdraw its arm from the shelving after picking the box without having to adjust joint angles (or minimizing the degree to which joint angles are adjusted), thereby enabling a simple solution to many keyhole problems.

Of course, it should be appreciated that the tasks depicted in FIGS. 2A-2C are but a few examples of applications in which an integrated mobile manipulator robot may be used, and the present disclosure is not limited to robots configured to perform only these specific tasks. For example, the robots described herein may be suited to perform tasks including, but not limited to, removing objects from a truck or container, placing objects on a conveyor belt, removing objects from a conveyor belt, organizing objects into a stack, organizing objects on a pallet, placing objects on a shelf, organizing objects on a shelf, removing objects from a shelf, picking objects from the top (e.g., performing a “top pick”), picking objects from a side (e.g., performing a “face pick”), coordinating with other mobile manipulator robots, coordinating with other warehouse robots (e.g., coordinating with AMRs), coordinating with humans, and many other tasks.

FIG. 2D depicts one embodiment of a pendant accessory 295 configured to couple to a robot 200 through an electrical interface 219. The pendant accessory 295 may be configured to enable a user to operate the robot 200 through a user interface of the pendant accessory 295. FIG. 2E depicts one embodiment of a pendant accessory 295 coupled to robot 200 through an electrical interface 219 of the robot. In some embodiments, a pendant accessory may couple to the robot through a dedicated pendant accessory interface, while in other embodiments, a pendant accessory may couple to the robot through an electrical interface configured to couple to multiple types of accessories such as a universal accessory interface (e.g., a universal electrical interface). In some embodiments, the pendant accessory 295 may communicate with the robot 200 wirelessly (e.g., through a wireless electrical interface), such as through wireless communication modules 820 and 920 associated with the pendant accessory and the robot, respectively. In embodiments with a wireless electrical interface, the wireless communication protocol may include a handshake authentication protocol between the robot and the pendant accessory in order to establish a connection.

The pendant accessory 295 may be configured to enable a user to operate one or more control systems of the robot 200 through a user interface of the pendant accessory 295. For example, if the robot 200 is malfunctioning in some way (e.g., a disabled sensor is triggering safety protocols that prevent the robot from moving), the pendant accessory 295 may enable a user to manually operate some or all of the functions of the robot 200. In some embodiments, the pendant accessory 295 may override and/or deactivate one or more safety protocols of the robot 200 when the pendant accessory is connected to the robot through an electrical interface (e.g., electrical interface 219). Disabling safety protocols may enable a user to operate the robot 200 to perform certain tasks that may be unsafe for the robot to perform autonomously. In some embodiments, the pendant accessory 295 is powered by the robot 200 when connected to the robot through an accessory interface (e.g., the electrical interface 219).

The user interface of the pendant accessory 295 may include one or more joysticks 802, one or more buttons 804, and/or one or more touchscreens 806. The touchscreen 806 may, in some embodiments, be removable from the remainder of the pendant accessory 295. In such embodiments, the removable touchscreen 806 may be configured to be powered by the pendant accessory 295 when the touchscreen 806 is coupled to the remainder of the pendant accessory 295. It should be appreciated that different embodiments of pendant accessories may include different combinations of the above elements of a user interface. For example, some embodiments of a user interface of a pendant accessory may include at least one joystick and at least one button, but may not include a touchscreen. Some embodiments of a user interface of a pendant accessory may include a touchscreen, but may not include any joysticks.

### Example Computing Device

Control of one or more of the robotic arm, the mobile base, the turntable, and the perception mast may be accomplished using one or more computing devices located on-board the mobile manipulator robot. For instance, one or more computing devices may be located within a portion of the mobile base with connections extending between the one or more computing devices and components of the robot that provide sensing capabilities and components of the robot to be controlled. In some embodiments, the one or more computing devices may be coupled to dedicated hardware configured to send control signals to particular components of the robot to effectuate operation of the various robot systems. In some embodiments, the mobile manipulator robot may include a dedicated safety-rated computing device configured to integrate with safety systems that ensure safe operation of the robot.

The computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the terms “physical processor” or “computer processor” generally refer to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

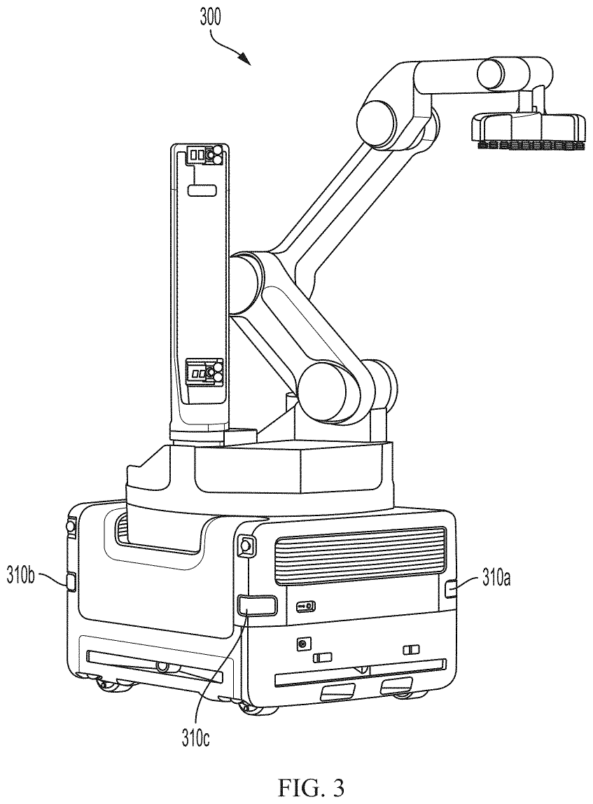

FIG. 3 depicts an omnidirectional mobile robot 300. Robot 300 includes a plurality of lighting modules 310a-310c disposed on the base of the robot. As shown, the lighting modules 310a-310c are disposed in the corners of the base of the robot 300. A fourth lighting module (not shown) may be disposed in the fourth corner of the base of the robot 300. Each of the lighting modules may include a plurality (e.g., an array) of light sources, such as light emitting diodes (LEDs), arranged to wrap around each of the corners of robot 300. The light sources included in each of the lighting modules may be individually controllable such that all light sources in a lighting module may be controlled together or may be controlled individually to provide a wide variety of lighting effects used to signal information about the robotic device 300. In some embodiments, the light sources include multi-color programmable LEDs such that both the color of the lighting modules and the timing of their activation (e.g., turning on and off) may be dynamically changed to represent different information. In some embodiments, the plurality of lighting modules may include a continuous band of lighting wrapping around all or a portion of an outer perimeter of the robot 300. In some embodiments, the plurality of lighting modules may include lighting arranged under all or a portion of an outer perimeter of the robot 300 such that the surface (e.g., the floor) on which the robot 300 is travelling is illuminated by the lighting modules. In some embodiments, one or more light sources arranged on perception mast 140 as described with reference to FIGS. 1A and 1B, may be configured as lighting modules. Such light sources arranged on the perception mast may be used together with a rotational motion of the perception mast to signal motion intent of the robot. For instance, the perception mast may be oriented in the direction of motion of the robot before motion begins, thereby signaling intent of the robot to move in that direction.

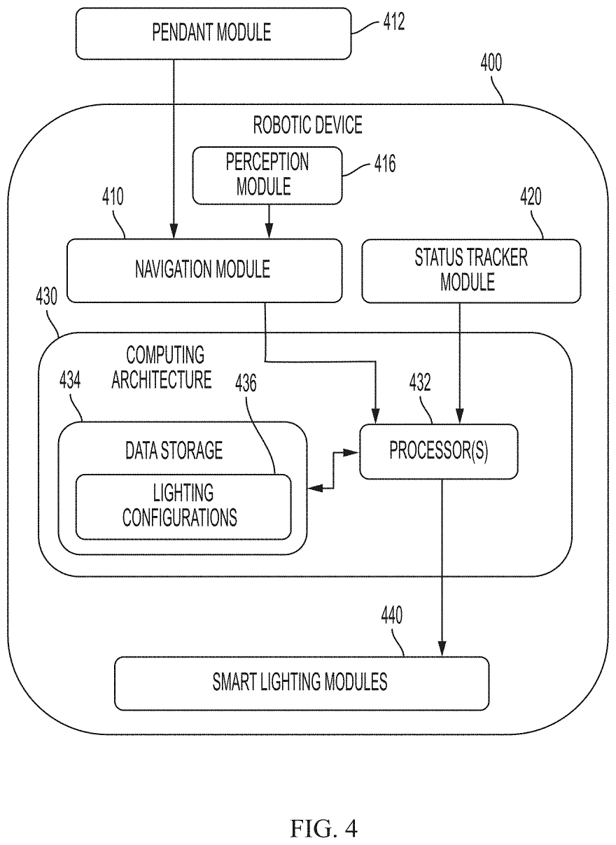

FIG. 4 illustrates an example computing architecture 410 for a robotic device 400, according to an illustrative embodiment of the invention. The computing architecture 410 includes one or more processors 432 and data storage 434 in communication with processor(s) 432. Data storage 434 may include one or more lighting configurations 436 that may be used by processor(s) 432 to determine how to control one or more lighting modules 440 of the robotic device 400 based on a behavior and/or state of the robotic device.

Robotic device 400 may also include a navigation module 410 configured to control movement of the robotic device 400 during driving. In some embodiments, robotic device 400 is an omnidirectional robot configured to operate in two different modes—autonomous mode and manual (or “controlled”) mode. As discussed above, when a pendant accessory is coupled (either wired or wirelessly) to the robotic device, the robotic device may automatically switch from autonomous mode into manual mode to enable an operator of the pendant accessory to control one or more functions of the robot including, but not limited to, driving the robot.

When operating in manual mode, navigation module 410 may be configured to receive input from pendant module 412 (e.g., pendant accessory 295 shown in FIGS. 2D and 2E) when being controlled by an operator. When operating in autonomous mode (i.e., without control from an operator using pendant module 412), navigation module 410 may be configured to receive input from perception module 416. Perception module 416 may include, for example, the perception modules in perception mast 140 shown and described above in FIGS. 1A-1B or any other perception modules that enable robotic device to safely navigate autonomously in an environment.

Robotic device 400 may also include status tracker module 420 configured to determine a current state or status of the robotic device. The output of navigation module 410 and status tracker module 420 may be provided as input to processor(s) 432 which may be configured to determine based, at least in part, on the stored lighting configurations 436 how to control one or more of lighting modules 440 to visually provide navigation and/or status information on the robotic device 400. It should be appreciated that in some embodiments, control signals may be sent directly from one or both of navigation module 310 and status tracker module 420 to control lighting modules 440 (i.e., without first being sent to computing architecture 430).

In some embodiments, lighting modules 440 may be controlled to display information associated with both navigation module 410 and status tracker module 420 at the same time. For instance, a first portion of the lighting modules 440 may be used to provide status information for the robotic device 400 and a second portion of the lighting modules may be used to simultaneously provide navigation information for the robotic device 400. Examples of providing both status information and navigation information at the same time are described below.

Instead of using traditional headlights or taillights on a mobile robot to show the direction the robot is travelling, some embodiments include a plurality of individually-controllable lighting modules (e.g., programmable LED modules), also referred to herein as “lighting modules,” that can be configured to display different lighting patterns and/or behaviors based on the robot behavior. For instance, the lighting modules may be controlled to display different patterns and/or behaviors based on the current operating mode of the robot. As an example, when the robot is operating in an autonomous mode, the robot may indicate a direction and/or vector of motion by making the light sources in the lighting modules facing the direction and/or vector of motion turn white (which may be perceived by others in the environment as headlights) and by making the light sources in the lighting modules facing away from the direction and/or vector of motion turn red (which may be perceived by others in the environment as taillights). In some embodiments, the lighting modules may be controlled to display information about the speed and/or acceleration of the robot. For instance, if the robot is accelerating or is not accelerating, the brightness of the lighting modules configured to be displayed red (the taillights) can be controlled to be at, for example, 50% brightness, and when the robot is decelerating, the brightness of the lighting modules configured to be displayed red can be changed, for example, to 100% brightness, or may change from 50% brightness to 100% brightness by pulsing the red lights to indicate that the robot is slowing down. By displaying the intent of what the robot is going to do next via the lighting modules, others in the environment (e.g., humans on foot or driving other machinery such as fork trucks, other robots, etc.) will be better informed about how to interact with the robot.

In some embodiments, the lighting modules are controlled when the robot is operating in autonomous mode to indicate characteristics of a motion vector output from the navigation module. For instance, when the motion vector becomes 90 degrees (robot is moving to the right) the lighting modules may be controlled to show the upcoming change in the motion path of the robot. The change in motion vector may be indicated using the lighting modules in any suitable way. For instance, the motion vector may be shown as rotating around the robot as the robot makes turns without actually rotating the orientation of the robot's base (e.g., by controlling which light sources are displayed white and are perceived as headlights and which light sources are displayed red and are perceived as taillights). Additionally or alternatively, the light sources in individual lighting modules may be controlled such that they strobe to the right or strobe to the left to indicate the upcoming direction of the robot. Dynamically updating which of the plurality of lighting modules are displayed white vs. red (or any other suitable color) enables others in the environment to clearly understand what the robot is doing next without requiring complex maneuvering of the robot (e.g., by rotating the base) to display such information.

In some embodiments, the lighting modules may be configured to operate differently when the robot is in a manual or “controlled” mode compared to when the robot is in an autonomous mode. For instance, when a pendant accessory is coupled (either wired or wirelessly) to the robot, instead of showing others in the environment what the robot is doing (or is intending to do next), the lighting modules may be used to inform an operator of the pendant accessory about the physical orientation of the robot with respect to the controls on the pendant accessory. Providing such information to the operator enables the operator to manually control the robot in a predictable way. Accordingly, when the robot is configured to operate in manual mode, one or more of the lighting modules may be configured to display information that shows the robot orientation with respect to the robot's frame of reference. For instance, the lighting modules located at the “front” of the robot may be configured to appear as headlights (e.g., by controlling the light sources therein to appear white), whereas the lighting modules located at the “rear” of the robot may be configured to appear as taillights (e.g., by controlling the light sources therein to appear red), as discussed above. Because in manual mode, the operator, rather than the robot, is making decisions of where to drive, providing the operator with orientation information about the robot may enable the operator to know what side of the robot corresponds to front, left, right, and/or rear without requiring the operator to move the robot to discover that information, resulting in an overall safer and more efficient operation of the robot.

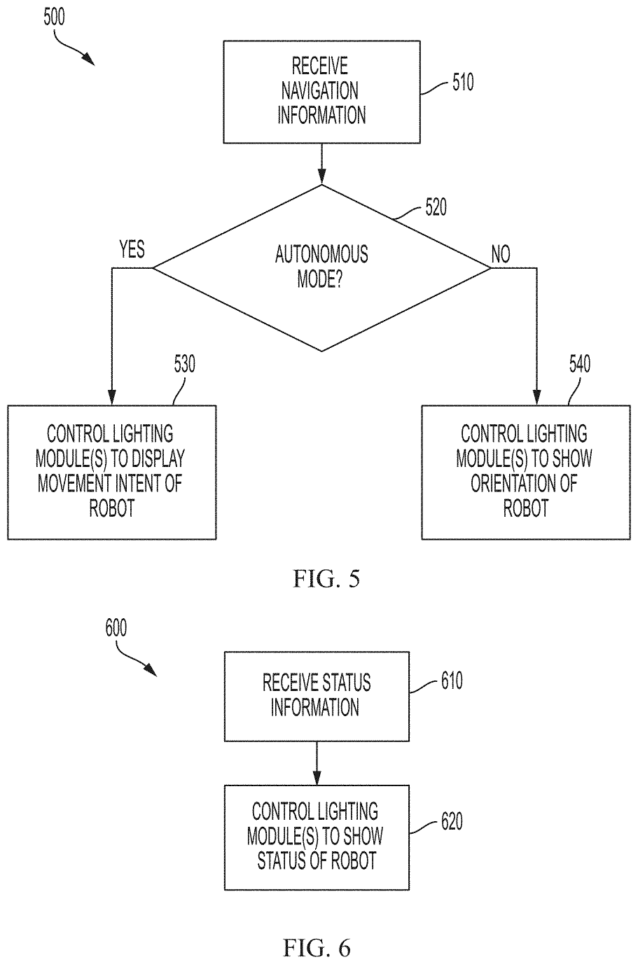

FIG. 5 illustrates a flowchart of a process 500 for controlling lighting modules of a mobile robot to display navigation information in accordance with some embodiments. Process 500 begins in act 510, in which navigation information is received, for example, from a navigation module of the robot. The navigation information may include information about one or more of the robot's speed, direction, and information about where the robot is intending to travel next. As discussed above, in some embodiments lighting modules may be controlled to display navigation information differently based on whether the robot is operating in autonomous mode or manual mode. Accordingly, process 500 proceeds to act 520, where it is determined whether the robot is operating in autonomous mode (or alternatively manual mode). Determining the current mode of the robot may be performed in any suitable way. For instance, when a pendant accessory (e.g., pendant accessory 295 shown in FIGS. 2D and 2E) is coupled (either wired or wirelessly) to the robot, the robot may automatically be determined to be in manual mode, and if a pendant accessory is not coupled to the robot, it may be assumed that the robot is in autonomous mode.

If it is determined in act 520 that the robot is operating in autonomous mode, process 500 proceeds to act 530, in which one or more of the lighting modules are controlled to display a movement intent of the robot based, at least in part, on the navigation information received in act 510. Non-limiting examples of controlling the lighting modules to show movement intent of the robot are described above. If it is determined in act 520 that the robot is not operating in autonomous mode (i.e., the robot is operating in manual or “controlled” mode) process 500 proceeds to act 540, in which one or more of the lighting modules are controlled based on the navigation information received in act 510 to show the orientation (e.g., front/back/left/right) of the robot relative to a reference frame of the pendant accessory to enable the operator of the robot to safely move the robot using the pendant accessory.

As described briefly above, in some embodiments one or more of the lighting modules may be used to display status information determined, for example, based on an output of a status tracker module. For instance, one or more of the light sources in one or more of the lighting modules can be controlled based on status information associated with the robot to flash a status code, while at the same time, showing navigation information, examples of which are discussed above. The inventors have recognized and appreciated that showing status codes using lighting modules may make the status information visible to others in the environment by helping to explain what the robot is currently doing when in autonomous mode.

Status information may be displayed using the lighting modules in any suitable way. For instance, the outside edges of the lighting modules may be controlled to be one color (e.g., solid white for headlights and solid red for taillights), whereas the inner portions of the lighting modules may be controlled to show status information (e.g., status codes or safety blink patterns). The status information displayed via the lighting modules may inform others (e.g., humans and/or other robots) in the environment of the robot, for example, if arm motion is enabled, wheel motion only, autonomous mode, low battery mode, low speed mode due to nearby objects, running task/job, completed task waiting for new job, among other things.

FIG. 6 illustrates a flowchart of a process 600 for controlling lighting modules of a mobile robot to display status information in accordance with some embodiments. Process 600 begins in act 610, in which status information is received, for example, from a status tracker module. Process 600 then proceeds to act 620 in which one or more of the lighting modules are controlled to display the status information. Status information may be displayed using all or a portion of the light sources within the lighting modules. As discussed above, in some embodiments one or more of the lighting modules may be controlled to show status information and navigation information at the same time using, for example, different light sources of the lighting modules. In some embodiments, different status information may be displayed (or may be displayed differently) depending on whether the robot is operating in autonomous mode or manual mode.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally, or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware or with one or more processors programmed using microcode or software to perform the functions recited above.

In this respect, it should be appreciated that embodiments of a robot may include at least one non-transitory computer-readable storage medium (e.g., a computer memory, a portable memory, a compact disk, etc.) encoded with a computer program (i.e., a plurality of instructions), which, when executed on a processor, performs one or more of the above-discussed functions. Those functions, for example, may include control of the robot and/or driving a wheel or arm of the robot. The computer-readable storage medium can be transportable such that the program stored thereon can be loaded onto any computer resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

Various aspects of the present invention may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, embodiments of the invention may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting.

What is claimed is:

1. A mobile robot, comprising:
a drive system configured to enable the mobile robot to be driven;
a navigation module configured to provide control instructions to the drive system;
a plurality of lighting modules, wherein each of the plurality of lighting modules includes a plurality of individually-controllable light sources; and
a controller configured to control an operation of the plurality of individually-controllable light sources based, at least in part, on navigation information received from the navigation module.

2. The mobile robot of claim 1, wherein the plurality of individually-controllable light sources are programmable light emitting diodes (LEDs).

3. The mobile robot of claim 1, further comprising a mobile base, and wherein the plurality of lighting modules are disposed at corners of the mobile base.

4. The mobile robot of claim 1, wherein controlling an operation of the plurality of individually-controllable light sources based, at least in part, on navigation information received from the navigation module comprises controlling the plurality of individually-controllable light sources to indicate a current travel direction or a future travel direction of the mobile robot.

5. The mobile robot of claim 4, wherein controlling the plurality of individually-controllable light sources to indicate the current travel direction or the future travel direction of the mobile robot comprises controlling a first set of lighting modules to display a white color and/or controlling a second set of lighting modules to display a red color, wherein the first set is located relative to the second set in the current travel direction or the future travel direction of the mobile robot.

6. The mobile robot of claim 1, wherein the navigation information received from the navigation module includes speed information for the mobile robot, and wherein controlling an operation of the plurality of individually-controllable light sources based, at least in part, on navigation information comprises controlling the plurality of individually-controllable light sources to indicate the speed information for the mobile robot.

7. The mobile robot of claim 1, further comprising:
a mode determining component configured to determine whether the mobile robot is operating in an autonomous mode or a manual mode, and
wherein the controller is further configured to control the operation of the plurality of individually-controllable light sources based, at least in part, on whether the mobile robot is determined to be operating in the autonomous mode or the manual mode.

8. The mobile robot of claim 7, wherein
the controller is configured to control the operation of the plurality of individually-controllable light sources to indicate a movement intent of the mobile robot when it is determined that the mobile robot is operating in autonomous mode, and
the controller is configured to control the operation of the plurality of individually-controllable light sources to indicate an orientation of the mobile robot relative to a reference frame when it is determined that the mobile robot is operating in manual mode.

9. The mobile robot of claim 1, further comprising:
a status tracker module configured to determine status information associated with one or more operations of the mobile robot, and
wherein the controller is further configured to control the operation of the plurality of individually-controllable light sources to indicate status information received from the status tracker module.

10. The mobile robot of claim 9, wherein the controller is further configured to control the operation of the plurality of individually-controllable light sources and/or at least one of the plurality of lighting modules to indicate the status information and the navigation information at a same time.

11. A method of controlling a plurality of lighting modules disposed on a mobile robot, each of the plurality of lighting modules including a plurality of individually-controllable light sources, the method comprising:
receiving navigation information indicating a direction of motion of the mobile robot; and
controlling, by at least one computing device, an operation of the plurality of individually-controllable light sources to indicate the direction of motion of the mobile robot.

12. The method of claim 11, wherein controlling an operation of the plurality of individually-controllable light sources to indicate the direction of motion of the robot comprises controlling at least some of the plurality of individually-controllable light sources to indicate a current travel direction of the mobile robot.

13. The method of claim 12, wherein controlling at least some of the plurality of individually-controllable light sources to indicate the current travel direction of the mobile robot comprises controlling a first set of lighting modules to display a white color and/or controlling a second set of lighting modules to display a red color, wherein the first set is located relative to the second set in the current travel direction of the mobile robot.

14. The method of claim 11, wherein controlling an operation of the plurality of individually-controllable light sources to indicate the direction of motion of the robot comprises controlling at least some of the plurality of individually-controllable light sources to indicate a future travel direction of the mobile robot.

15. The method of claim 14, wherein controlling at least some of the plurality of individually-controllable light sources to indicate the future travel direction of the mobile robot comprises:
controlling a first set of lighting modules to display a white color and/or controlling a second set of lighting modules to display a red color, wherein the first set is located relative to the second set in a current travel direction of the mobile robot; and
controlling a third set of lighting modules to display the white color and/or controlling a fourth set of lighting modules to display the red color, wherein the third set is different from the first set and the fourth set is different from the second set.

16. The method of claim 11, wherein the navigation information includes speed information for the mobile robot, and wherein the method further comprises:
controlling an operation of the plurality of individually-controllable light sources to indicate the speed information for the mobile robot.

17. The method of claim 11, further comprising:
determining whether the mobile robot is operating in an autonomous mode or a manual mode; and
controlling the operation of the plurality of individually-controllable light sources based, at least in part, on whether the mobile robot is determined to be operating in the autonomous mode or the manual mode.

18. The method of claim 17, wherein determining whether the mobile robot is operating in an autonomous mode or a manual mode comprises determining that the mobile robot is operating in the manual mode when a pendant accessory is communicatively coupled to the mobile robot.

19. The method of claim 17, wherein controlling the operation of the plurality of individually-controllable light sources based, at least in part, on whether the mobile robot is determined to be operating in the autonomous mode or the manual mode comprises:
controlling the operation of the plurality of individually-controllable light sources to indicate a movement intent of the mobile robot when it is determined that the mobile robot is operating in autonomous mode; and
controlling the operation of the plurality of individually-controllable light sources to indicate an orientation of the mobile robot relative to a reference frame when it is determined that the mobile robot is operating in manual mode.

20. The method of claim 11, further comprising:
controlling the operation of the plurality of individually-controllable light sources to indicate status information associated with the mobile robot and the direction of motion of the mobile robot at a same time.

21. The method of claim 20, wherein controlling the operation of the plurality of individually-controllable light sources to indicate the status information associated with the mobile robot and the direction of motion of the mobile robot at a same time comprises controlling the operation of the plurality of individually-controllable light sources for one of the plurality of lighting modules such that the lighting module indicates the status information and the direction of motion of the mobile robot at the same time.
